(19) United States
(12) Patent Application Publication
(10) Pub. No.: US 2026/0005302 A1
(43) Pub. Date: Jan. 1, 2026

(54) ELECTROLYTE FOR RECHARGEABLE LITHIUM BATTERY AND RECHARGEABLE LITHIUM BATTERY INCLUDING THE SAME

(71) Applicant: SAMSUNG SDI CO., LTD., Yongin-si (KR)

(72) Inventors: Hongryeol PARK, Yongin-si (KR); HYUNBONG CHOI, Yongin-si (KR); Sangwoo PARK, Yongin-si (KR); Woojung JI, Yongin-si (KR); Sohee KIM, Yongin-si (KR); Yeji YANG, Yongin-si (KR); Dasol JUN, Yongin-si (KR); Youngkyeong SHIN, Yongin-si (KR); SANGHOON KIM, Yongin-si (KR)

(21) Appl. No.: 19/077,263

(22) Filed: Mar. 12, 2025

(30) Foreign Application Priority Data
Jun. 27, 2024 (KR) 10-2024-0084359

(51) Int. Cl. H01M 10/0567; H01M 10/0525; H01M 10/42

(52) U.S. Cl. CPC H01M 10/0567; H01M 10/0525; H01M 10/4235; H01M 2300/0025

(57) ABSTRACT

An electrolyte for a rechargeable lithium battery including a non-aqueous organic solvent, a lithium salt, and an additive is provided. The additive includes an aliphatic diisocyanate compound and a compound represented by Chemical Formula 1. A detailed description of Chemical Formula 1 is as described in this disclosure.

### CROSS-REFERENCE TO RELATED APPLICATION

This application claims priority to and the benefit of Korean Patent Application No. 10-2024-0084359, filed on Jun. 27, 2024 in the Korean Intellectual Property Office, the disclosure of which is hereby incorporated by reference in its entirety.

### BACKGROUND

### 1. Field

The present disclosure relates to an electrolyte for a rechargeable lithium battery and a rechargeable lithium battery including the same.

### 2. Background

Recently, with the rapid proliferation of battery-using electronic and/or electric devices, such as mobile phones, laptop computers, electric vehicles, and/or the like, there has been a significant increase in the demand for batteries e.g., rechargeable batteries, with relatively high energy density and high capacity. Consequently, extensive research has been conducted to enhance the performance of such rechargeable batteries, e.g., rechargeable lithium batteries.

A rechargeable lithium battery includes a positive electrode, a negative electrode, and an electrolyte. Both the positive and negative electrodes (e.g., each) include an active material in which intercalation and deintercalation (e.g. of lithium ions) are possible (i.e., the active material is cable of intercalating and deintercalating lithium ions). For example, the rechargeable lithium battery, generates electrical energy caused by oxidation and reduction reactions if (e.g., when) lithium ions are intercalated and deintercalated.

### SUMMARY

One or more aspects are directed toward an electrolyte for a rechargeable lithium battery offering (with) enhanced (e.g., increased or improved) cycle-life characteristics, excellent or suitable high-temperature characteristics, and superior stability.

One or more aspects are directed toward a rechargeable lithium battery including the electrolyte.

Additional aspects will be set forth in part in the description which follows and, in part, will be apparent from the description, or may be learned by practice of the presented embodiments of the disclosure.

According to one or more embodiments of the present disclosure, an electrolyte for a rechargeable lithium battery may include: a non-aqueous organic solvent; a lithium salt; and an additive.

The additive may include: an aliphatic diisocyanate compound; and a compound represented by Chemical Formula 1.

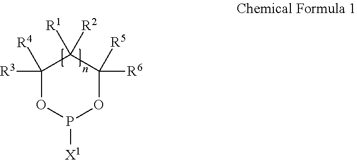

In Chemical Formula 1,
X¹ may be a fluoro group, a chloro group, a bromo group, or an iodo group,
R¹ to R⁶ may each independently be hydrogen, a cyano group, an isocyanate group, an isothiocyanate group, a halogen-substituted sulfonate group, a sulfonate group substituted with a C1 to C10 alkyl group, a sulfonate group substituted by a C1 to C10 fluoroalkyl group, a substituted or unsubstituted C1 to C20 alkyl group, a substituted or unsubstituted C1 to C20 alkoxy group, a substituted or unsubstituted C2 to C20 alkenyl group, a substituted or unsubstituted C2 to C20 alkynyl group, a substituted or unsubstituted C3 to C20 cycloalkyl group, a substituted or unsubstituted C6 to C20 aryl group, or a substituted or unsubstituted C2 to C20 heteroaryl group, and
n may be an integer of 0 or 1,

According to one or more embodiments of the present disclosure, an electrolyte for a rechargeable lithium battery may include: a non-aqueous organic solvent; a lithium salt; and an additive.

The additive may include: an aliphatic diisocyanate compound; and a compound represented by Chemical Formula 2.

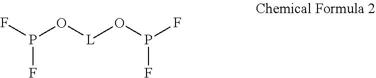

In Chemical Formula 2, L may include a substituted or unsubstituted C1 to C10 alkylene group or a substituted or unsubstituted C2 to C10 ether group.

According to one or more embodiments of the present disclosure, a rechargeable lithium battery may include: a positive electrode that includes a positive electrode active material; a negative electrode that includes a negative electrode active material; and the electrolyte for the rechargeable lithium battery.

### BRIEF DESCRIPTION OF DRAWINGS

FIG. 1 illustrates a simplified conceptual diagram showing a rechargeable lithium battery according to one or more embodiments of the present disclosure.

FIGS. 2 to 5 illustrate simplified diagrams each showing a rechargeable lithium battery according to one or more embodiments of the present disclosure.

### DETAILED DESCRIPTION

In order to sufficiently understand the configuration and effect of the present disclosure, some embodiments of the present disclosure will be described with reference to the accompanying drawings. It should be noted, however, that the present disclosure is not limited to the following example embodiments, and may be implemented in one or more suitable forms. Rather, the example embodiments are provided only to disclose the present disclosure and let those skilled in the art fully know the scope of the present disclosure.

In this description, it will be understood that, if (e.g., when) an element is referred to as being on another element, the element can be directly on the other element or intervening elements may be present between therebetween. In the drawings, thicknesses of some components are exaggerated for effectively explaining the technical contents. Like reference numerals refer to like elements throughout, and duplicative descriptions thereof is not provided the specification.

Unless otherwise specially noted in this description, an expression in singular form may include the expression of plural form(s). For example, unless otherwise specially noted, the phrase “A or B” may indicate “A but not B”, “B but not A”, and “A and B”.

The terms “comprises/includes,” “comprising/including,” “comprise/include,” “having,” “has,” and/or “have”, as used in this disclosure, are intended to designate the presence of an embodied aspect, number, step (e.g., act or task), element, and/or a (e.g., any suitable) combination thereof. However, the use of these terms does not preclude or exclude the possibility, presence, and/or addition of one or more other components, features, numbers, steps (e.g., acts or tasks), elements, and/or a (e.g., any suitable) combination thereof.

As used herein, the term “combination thereof” may refer to a mixture, a stack, a composite, a copolymer, an alloy, a blend, or a reaction product.

In one or more embodiments, the term “layer” herein includes not only a shape formed or provided on the whole surface if (e.g., when) viewed from a plan view, but also a shape formed or provided on a partial surface.

It will be understood that, although the terms “first,” “second,” “third,” and/or the like may be utilized herein to describe one or more suitable elements, components, regions, layers and/or sections, these elements, components, regions, layers and/or sections should not be limited by these terms. These terms are only utilized to distinguish one element, component, region, layer or section from another element, component, region, layer, or section. Thus, a first element, component, region, layer, or section described herein may be termed a second element, component, region, layer or section without departing from the teachings set forth herein.

As utilized herein, the term “and/or” includes any, and all, combinations of one or more of the associated listed items. Expressions such as “at least one of,” “one of,” and “selected from,” if (e.g., when) preceding a list of elements, modify the entire list of elements and do not modify the individual elements of the list. For example, the expressions “at least one of a to c,” “at least one of a, b or c,” and “at least one of a, b and/or c” may indicate only a, only b, only c, both (e.g., simultaneously) a and b, both (e.g., simultaneously) a and c, both (e.g., simultaneously) b and c, all of a, b, and c, or variations thereof.

Spatially relative terms, such as “beneath,” “below,” “lower,” “above,” “upper” and/or the like, may be utilized herein to easily describe the relationship between one element or feature and another element or feature. It will be understood that the spatially relative terms are intended to encompass different orientations of a device in utilization or operation in addition to the orientation illustrated in the drawings. For example, if (e.g., when) the device in the drawings is turned over, elements described as “below” or “beneath” other elements or features will be oriented “above” the other elements or features. Thus, the example term “below” can encompass both (e.g., simultaneously) the orientations of above and below. The device may be otherwise oriented (rotated 90 degrees or at other orientations), and the spatially relative terms utilized herein may be interpreted accordingly.

The terminology utilized herein is utilized for the purpose of describing particular embodiments only, and is not intended to limit the present disclosure. Unless otherwise defined, all terms (including chemical, technical and scientific terms) utilized herein have the same meaning as commonly understood by one of ordinary skill in the art to which this disclosure pertains. It will be further understood that terms, such as those defined in commonly utilized dictionaries, should be interpreted as having a meaning that is consistent with their meaning in the context of the related art and the present disclosure, and will not be interpreted in an idealized or overly formal sense.

Example embodiments are described herein with reference to cross-sectional views, which are schematic views of idealized embodiments. As such, variations from the shapes of the illustrations as a result, for example, of manufacturing techniques and/or tolerances, are to be expected. Thus, embodiments described herein should not be construed as being limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the drawings are schematic in nature and their shapes are not intended to illustrate the precise shape of a region and are not intended to limit the scope of the present claims.

The term “may” will be understood to refer to “one or more embodiments of the present disclosure,” some of which include the described element and some of which exclude that element and/or include an alternate element. Similarly, alternative language such as “or” refers to “one or more embodiments of the present disclosure,” each including a corresponding listed item.

In this context, “consisting essentially of” indicates that any additional components will not materially affect the chemical, physical, optical or electrical properties of the semiconductor film.

In the context of the present application and unless otherwise defined, the terms “use,” “using,” and “used” may be considered synonymous with the terms “utilize,” or “utilization,” “utilizing,” and “utilized,” respectively.

The term “particle diameter” as utilized herein refers to an average diameter of particles if (e.g., when) the particles are spherical, and refers to an average major axis length of particles if (e.g., when) the particles are non-spherical. For example, unless otherwise especially defined in this description, a particle diameter may be an average particle diameter. For example, a particle diameter indicates an average particle diameter (D₅₀) where a cumulative volume is about 50 volume % in a particle size distribution. The average particle diameter (D₅₀) may be measured by a method widely suitable to those skilled in the art, for example, by a particle size analyzer, a transmission electron microscope (TEM) image, or a scanning electron microscope (SEM) image. A dynamic light-scattering measurement device may be used to perform a data analysis, the number of particles is counted for each particle size range, and then from this, an average particle diameter (D₅₀) value may be obtained through a calculation. Unless otherwise defined, the average particle diameter may refer to the diameter (D₅₀) of particles having a cumulative volume of 50 volume % in the particle size distribution. Dissimilarly, a laser scattering method may be utilized to measure the average particle diameter (D₅₀). In the laser scattering method, a target particle is distributed in a dispersion solvent, introduced into a laser scattering particle measurement device (e.g., MT3000 commercially available from Microtrac, Inc), irradiated with ultrasonic waves of 28 kHz at a power of 60 W, and then an average particle diameter (D₅₀) is calculated in the 50% standard of particle diameter distribution in the measurement device. As used herein, if (e.g., when) a definition is not otherwise provided, the average particle diameter refers to a diameter (D₅₀) of particles having a cumulative volume of 50 volume % in the particle size distribution that is obtained by measuring the size (diameter or major axis length) of about 20 particles at random in a scanning electron microscope image.

In this description, unless otherwise separately defined, the term “substituted” may refer to that at least one hydrogen of a substituent or a compound is substituted by deuterium, a halogen group, a hydroxyl group, an amino group, a C1 to C30 amine group, a nitro group, a C1 to C40 silyl group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, C1 to C20 alkoxy group, a C1 to C10 fluoroalkyl group, a cyano group, or a combination thereof.

In more detail, the term “substituted” may refer to that at least one hydrogen of a substituent or a compound is substituted by deuterium, a halogen group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C10 fluoroalkyl group, or a cyano group. For example, the term “substituted” may refer to that at least one hydrogen of a substituent or a compound is substituted by deuterium, a halogen group, a C1 to C20 alkyl group, a C6 to C30 aryl group, a C1 to C10 fluoroalkyl group, or a cyano group. Alternatively, the term “substituted” may refer to that at least one hydrogen of a substituent or a compound is substituted by deuterium, a halogen group, a C1 to C5 alkyl group, a C6 to C18 aryl group, a C1 to C5 fluoroalkyl group, or a cyano group. For example, the term “substituted” may refer to that at least one hydrogen of a substituent or a compound is substituted by deuterium, a cyano group, a halogen group, a methyl group, an ethyl group, a propyl group, a butyl group, a phenyl group, a biphenyl group, a terphenyl group, a trifluomethyl group, or a naphthyl group.

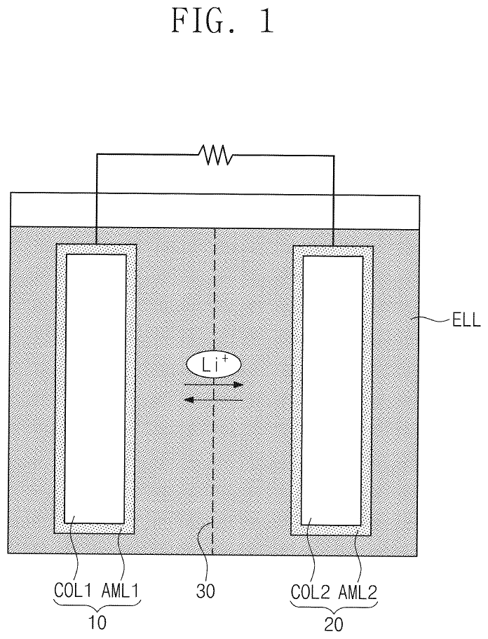

### Description of FIG. 1

FIG. 1 illustrates a simplified conceptual diagram showing a rechargeable lithium battery according to one or more embodiments of the present disclosure. Referring to FIG. 1, a rechargeable lithium battery may a positive electrode 10, a negative electrode 20, a separator 30, and an electrolyte ELL.

The positive electrode 10 and the negative electrode 20 may be spaced and/or apart (e.g., spaced apart or separated) from each other across the separator 30. The separator 30 may be arranged between the positive electrode 10 and the negative electrode 20. The positive electrode 10, the negative electrode 20, and the separator 30 may be in contact with the electrolyte ELL. The positive electrode 10, the negative electrode 20, and the separator 30 may be impregnated in (and/or with) the electrolyte ELL.

The electrolyte ELL may be a medium by which lithium ions are transferred between the positive electrode 10 and the negative electrode 20. In the electrolyte ELL, the lithium ions may move through the separator 30 toward one selected from among the positive electrode 10 and the negative electrode 20.

### Positive Electrode 10

The positive electrode 10 for a rechargeable lithium battery may include a current collector COL1 and a positive electrode active material layer AML1 formed on the current collector COL1. The positive electrode active material layer AML1 may include a positive electrode active material and further include a binder and/or a conductive material (e.g., electron conductor).

For example, the positive electrode 10 may further include an additive that can serve as a sacrificial positive electrode.

An amount of the positive electrode active material may be about 90 wt % to about 99.5 wt % relative to 100 wt % of the positive electrode active material layer AML1. An amount of each of the binder and the conductive material may be about 0.5 wt % to about 5 wt % relative to 100 wt % of the positive electrode active material layer AML1.

The binder may serve to improve attachment of positive electrode active material particles to each other and also to improve attachment of the positive electrode active material to the current collector COL1. The binder may include, for example, polyvinyl alcohol, carboxymethyl cellulose, hydroxypropyl cellulose, diacetyl cellulose, polyvinylchloride, carboxylated polyvinylchloride, polyvinylfluoride, ethylene oxide-containing polymer, polyvinylpyrrolidone, polyurethane, polytetrafluoroethylene, polyvinylidene fluoride, polyethylene, polypropylene, styrene-butadiene rubber, (meth)acrylated styrene-butadiene rubber, epoxy resin, (meth)acrylic resin, polyester resin, or nylon, but the present disclosure is not limited thereto.

The conductive material may be used to provide an electrode with conductivity, and any suitable conductive material that does not cause a chemical change in a battery may be used as the conductive material. The conductive material may include, for example, a carbon-based material such as natural graphite, artificial graphite, carbon black, acetylene black, Ketjen black, carbon fiber, carbon nano-fiber, and carbon nano-tube; a metal powder or metal fiber containing one or more of copper, nickel, aluminum, and silver; a conductive polymer such as a polyphenylene derivative; and/or a (e.g., any suitable) mixture thereof.

Aluminum (Al) may be used as the current collector COL1, but the present disclosure is not limited thereto.

### Positive Electrode Active Material

The positive electrode active material in the positive electrode active material layer AML1 may include a compound (e.g., lithiated intercalation compound) that can reversibly intercalate and deintercalate lithium. For example, the positive electrode active material may include at least one kind of composite oxide including lithium and metal that is selected from among cobalt, manganese, nickel, and/or a (e.g., any suitable) combination thereof.

The composite oxide may include lithium transition metal composite oxide, for example, lithium-nickel-based oxide, lithium-cobalt-based oxide, lithium-manganese-based oxide, lithium-iron-phosphate-based compounds, cobalt-free nickel-manganese-based oxide, and/or a (e.g., any suitable) combination thereof.

For example, the positive electrode active material may include at least one compound represented (e.g., expressed) by one selected from among chemical formulae: LiₐA_{1-b}X_{b}O_{2-c}D_{c} (where 0.90≤a≤1.8, 0≤b≤0.5, and 0≤c≤0.05); LiₐMn_{2-b}X_{b}O_{4-c}D_{c} (where 0.90≤a≤1.8, 0≤b≤0.5, and 0≤c≤0.05); LiₐNi_{1-b-c}CO_{b}X_{c}O_{2-α}D_{α} (where 0.90≤a≤1.8, 0≤b≤0.5, 0<c<0.5, and 0<α<2); LiₐNi_{1-b-c}Mn_{b}X_{c}O_{2-α}D_{α} (where 0.90≤a≤1.8, 0≤b≤0.5, 0≤c≤0.5, and 0<α<2); LiₐNi_{b}Co_{c}L¹_{d}GₑO₂ (where 0.90≤a≤1.8, 0≤b≤0.9, 0≤c≤0.5, 0≤d≤0.5, and 0≤e≤0.1); LiₐNiG_{b}O₂ (where 0.90≤a≤1.8 and 0.001≤b≤0.1); LiₐCoG_{b}O₂ (where 0.90≤a≤1.8 and 0.001≤b≤0.1); LiₐMn_{1-b}G_{b}O₂ (where 0.90≤a≤1.8 and 0.001≤b≤0.1); LiₐMn₂G_{b}O₄ (where 0.90≤a≤1.8 and 0.001≤b≤0.1); LiₐMn_{1-g}G_{g}PO₄ (where 0.90≤a≤1.8 and 0≤g≤0.5); Li_{(3-f)}Fe₂(PO₄)₃ (where 0≤f≤2); LiₐFePO₄ (where 0.90≤a≤1.8).

In the preceding chemical formulae, A may be Ni, Co, Mn, and/or a (e.g., any suitable) combination thereof, X may be Al, Ni, Co, Mn, Cr, Fe, Mg, Sr, V, a rare-earth element, and/or a (e.g., any suitable) combination thereof, D may be O, F, S, P, and/or a (e.g., any suitable) combination thereof, G may be Al, Cr, Mn, Fe, Mg, La, Ce, Sr, V, and/or a (e.g., any suitable) combination thereof, and L¹ may be Mn, Al, or a combination thereof.

For example, the positive electrode active material may be a high-nickel-based positive electrode active material having a nickel amount of equal to or greater than about 80 mol %, equal to or greater than about 85 mol %, equal to or greater than about 90 mol %, equal to or greater than about 91 mol %, or equal to or greater than about 94 mol % and equal to or less than about 99 mol % relative to 100 mol % of metal devoid of lithium in the lithium transition metal composite oxide. The high-nickel-based positive electrode active material may achieve high capacity and thus may be applied to a high-capacity and high-density rechargeable lithium battery.

### Negative Electrode 20

The negative electrode 20 for a rechargeable lithium battery may include a current collector COL2 and a negative electrode active material layer AML2 positioned on the current collector COL2. The negative electrode active material layer AML2 may include a negative electrode active material and may further include a binder and/or a conductive material (e.g., electron conductor).

For example, the negative electrode active material layer AML2 may include a negative electrode active material of about 90 wt % to about 99 wt %, a binder of about 0.5 wt % to about 5 wt %, and a conductive material of about 0 wt % to about 5 wt %.

The binder may serve to improve attachment of negative electrode active material particles to each other and also to improve attachment of the negative electrode active material to the current collector COL2. The binder may include a non-aqueous binder, an aqueous binder, a dry binder, and/or a (e.g., any suitable) combination thereof.

The non-aqueous binder may include polyvinyl chloride, carboxylated polyvinyl chloride, polyvinyl fluoride, ethylene propylene copolymer, polystyrene, polyurethane, polytetrafluoroethylene, polyvinylidene fluoride, polyethylene, polypropylene, polyamide imide, polyimide, and/or a (e.g., any suitable) combination thereof.

The aqueous binder may include styrene-butadiene rubber, (meth)acrylated styrene-butadiene rubber, (meth)acrylonitrile-butadiene rubber, (meth)acrylic rubber, butyl rubber, fluoro elastomer, polyethylene oxide, polyvinyl pyrrolidone, polyepichlorohydrin, polyphosphazene, poly(meth)acrylonitrile, ethylene propylene diene copolymer, polyvinyl pyridine, chlorosulfonated polyethylene, latex, polyester resin, (meth)acrylic resin, phenolic resin, epoxy resin, polyvinyl alcohol, and/or a (e.g., any suitable) combination thereof.

If (e.g., when) an aqueous binder is used as the negative electrode binder, a cellulose-based compound capable of providing viscosity may further be included. The cellulose-based compound may include one or more of carboxymethyl cellulose, hydroxypropylmethyl cellulose, methyl cellulose, and alkali metal salts thereof. The alkali metal may include Na, K, or Li.

The dry binder may include a fibrillizable polymer material, for example, polytetrafluoroethylene, polyvinylidene fluoride, polyvinylidene fluoride-hexafluoropropylene copolymer, polyethylene oxide, and/or a (e.g., any suitable) combination thereof.

The conductive material may be used to provide an electrode with conductivity, and any suitable conductive material that does not cause a chemical change in a battery may be used as the conductive material. For example, the conductive material may include a carbon-based material such as natural graphite, artificial graphite, carbon black, acetylene black, Ketjen black, carbon fiber, carbon nano-fiber, and carbon nano-tube; a metal powder or metal fiber including one or more of copper, nickel, aluminum, and silver; a conductive polymer such as a polyphenylene derivative; and/or a (e.g., any suitable) mixture thereof.

The current collector COL2 may include a copper foil, a nickel foil, a stainless-steel foil, a titanium foil, a nickel foam, a copper foam, a polymer substrate coated with a conductive metal, and/or a (e.g., any suitable) combination thereof.

### Negative Electrode Active Material

The negative electrode active material in the negative electrode active material layer AML2 may include a material that can reversibly intercalate and deintercalate lithium ions, lithium metal, a lithium metal alloy, a material that can dope and de-dope lithium, or transition metal oxide.

The material that can reversibly intercalate and deintercalate lithium ions may include a carbon-based negative electrode active material, for example, crystalline carbon, amorphous carbon, and/or a (e.g., any suitable) combination thereof. For example, the crystalline carbon may include graphite such as non-shaped, sheet-shaped, flake-shaped, sphere-shaped, or fiber-shaped natural or artificial graphite, and the amorphous carbon may include soft carbon, hard carbon, mesophase pitch carbon, or calcined coke.

The lithium metal alloy may include an alloy of lithium and metal that is selected from among Na, K, Rb, Cs, Fr, Be, Mg, Ca, Sr, Si, Sb, Pb, In, Zn, Ba, Ra, Ge, Al, and Sn.

The material that can dope and de-dope lithium may include a Si-based negative electrode active material or a Sn-based negative electrode active material. The Si-based negative electrode active material may include silicon, silicon-carbon composite, SiOx (where 0<x≤2), Si-Q alloy (where Q is alkali metal, alkaline earth metal, Group 13 element, Group 14 element (except for Si), Group 15 element, Group 16 element, transition metal, a rare-earth element, or a combination thereof), or a combination thereof. The Sn-based negative electrode active material may include Sn, SnOx (0<x≤2), e.g., SnO₂, a Sn-based alloy, a combination thereof.

The silicon-carbon composite may be a composite of silicon and amorphous carbon. According to one or more embodiments, the silicon-carbon composite may have a structure in which the amorphous carbon is coated on a surface of the silicon particle. For example, the silicon-carbon composite may include a secondary particle (core) in which primary silicon particles are assembled (agglomerated), and an amorphous carbon coating layer (shell) positioned on a surface of the secondary particle. The amorphous carbon may also be positioned between the primary silicon particles, and for example, the primary silicon particles may be coated with the amorphous carbon. The secondary particles may also be dispersed within an amorphous carbon matrix.

The silicon-carbon composite may further include crystalline carbon. For example, the silicon-carbon composite may include a core including crystalline carbon and silicon particles and may also include an amorphous carbon coating layer positioned on a surface of the core.

The Si-based negative electrode active material or the Sn-based negative electrode active material may be used in combination with a carbon-based negative electrode active material.

### Separator 30

Based on type (kind) of the rechargeable lithium battery, the separator 30 may be present between positive electrode 10 and the negative electrode 20. The separator 30 may include one or more of polyethylene, polypropylene, and polyvinylidene fluoride, and may have a multi-layered separator thereof such as a polyethylene/polypropylene bi-layered separator, a polyethylene/polypropylene/polyethylene tri-layered separator, and a polypropylene/polyethylene/polypropylene tri-layered separator.

The separator 30 may include a porous substrate and a coating layer positioned on one or opposite surfaces of the porous substrate, which coating layer includes an organic material, an inorganic material, and/or a (e.g., any suitable) combination thereof.

The porous substrate may be a polymer layer including one selected from among polyolefin such as polyethylene and polypropylene, polyester such as polyethylene terephthalate and polybutylene terephthalate, polyacetal, polyamide, polyimide, polycarbonate, polyetherketone, polyaryletherketone, polyetherimide, polyamideimide, polybenzimidazole, polyethersulfone, polyphenyleneoxide, cyclic olefin copolymer, polyphenylenesulphide, polyethylene naphthalate, glass fiber, and polytetrafluoroethylene (e.g., Teflon), or may be a copolymer or mixture including two or more of the preceding materials mentioned herein.

The organic material may include a polyvinylidenefluoride-based copolymer or a (meth) acrylic copolymer.

The inorganic material may include an inorganic particle selected from among Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, Boehmite, and/or a (e.g., any suitable) combination thereof, but the present disclosure is not limited thereto.

The organic material and the inorganic material may be present mixed in one coating layer or may be present as a stack of a coating layer including the organic material and a coating layer including an inorganic material.

### Electrolyte ELL

The electrolyte ELL for a rechargeable lithium battery may include a non-aqueous organic solvent and a lithium salt.

The non-aqueous organic solvent may serve as a medium for transmitting ions that participate in an electrochemical reaction of the battery.

The non-aqueous organic solvent may include a carbonate-based solvent, an ester-based solvent, an ether-based solvent, a ketone-based solvent, an alcohol-based solvent, an aprotic solvent, and/or a (e.g., any suitable) combination thereof.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), or butylene carbonate (BC).

The ester-based solvent may include methyl acetate, ethyl acetate, n-propyl acetate, dimethyl acetate, methyl propionate, ethyl propionate, decanolide, mevalonolactone, valerolactone, or caprolactone.

The ether-based solvent may include dibutyl ether, tetraglyme, diglyme, dimethoxyethane, 2-methyltetrahydrofuran, 2.5-dimethyltetrahydrofuran, or tetrahydrofuran. The ketone-based solvent may include cyclohexanone. The alcohol-based solvent may include ethyl alcohol or isopropyl alcohol. The aprotic solvent may include nitriles such as R-CN (where R is a hydrocarbon group having a C2 to C20 linear, branched, or cyclic structure and may include a double bond, an aromatic ring, or an ether group); amides such as dimethylformamide; dioxolanes such as 1,3-dioxolane or 1,4-dioxolane; or sulfolanes.

The non-aqueous organic solvent may be used alone or in a mixture of two or more substances.

In some embodiments, if (e.g., when) a carbonate-based solvent is used, a cyclic carbonate and a chain carbonate may be mixed and used, and the cyclic carbonate and the chain carbonate may be mixed in a volume ratio of about 1:1 to about 1:9.

The lithium salt may be a material that is dissolved in the non-aqueous organic solvent to serve as a supply source of lithium ions in a battery and plays a role in enabling a basic operation of a rechargeable lithium battery and in promoting the movement of lithium ions between positive and negative electrodes. The lithium salt may include, for example, at least one selected from among LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{y}F_{2y+1}SO₂) (where x and y are integers of 1 to 20), lithium trifluoromethane sulfonate, lithium tetrafluoroethanesulfonate, lithium difluorobis (oxalato) phosphate (LiDFBOP), and lithium bis (oxalato) borate (LiBOB)

The following will describe an electrolyte for a rechargeable lithium battery according to one or more embodiments.

An electrolyte for a rechargeable lithium battery according to one or more embodiments may include a non-aqueous organic solvent, a lithium salt, and an additive. The additive may include an aliphatic diisocyanate compound and a compound represented by Chemical Formula 1.

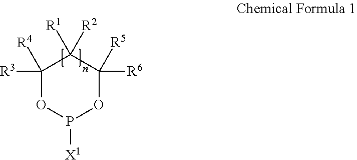

In Chemical Formula 1,
X¹ may be a fluoro group, a chloro group, a bromo group, or an iodo group.
R¹ to R⁶ may each independently be hydrogen, a cyano group, an isocyanate group, an isothiocyanate group, a halogen-substituted sulfonate group, a sulfonate group substituted with a C1 to C10 alkyl group, a sulfonate group substituted by a C1 to C10 fluoroalkyl group, a substituted or unsubstituted C1 to C20 alkyl group, a substituted or unsubstituted C1 to C20 alkoxy group, a substituted or unsubstituted C2 to C20 alkenyl group, a substituted or unsubstituted C2 to C20 alkynyl group, a substituted or unsubstituted C3 to C20 cycloalkyl group, a substituted or unsubstituted C6 to C20 aryl group, or a substituted or unsubstituted C2 to C20 heteroaryl group.
n may be an integer of 0 or 1.

The compound represented by Chemical Formula 1 may stabilize a LiPF₆ salt in the electrolyte, thereby preventing or reducing hydrolysis (e.g., of the compounds and/or other components of the electrolyte).

The compound represented by Chemical Formula 1 may be oxidized on the surface of a positive electrode to form a phosphate functional group, and the functional group may serve as an anion receptor to stably form hexafluorophosphate (PF₆⁻) (e.g., increase a concentration of PF₆⁻) and to increase an ion pair separation of Li⁺ and PF₆⁻, with the result that solubility of LiF in the electrolyte may be improved to reduce interfacial resistance.

In some embodiments, the compound represented by Chemical Formula 1 may be oxidized and decomposed on the surface of the positive electrode to form a cathode electrolyte interface (CEI) layer with high heat resistance on the surface of the positive electrode, thereby suppressing or reducing decomposition of the electrolyte even at high-temperature storage.

For example, the compound represented by Chemical Formula 1 may have an oxidation potential less than that of a solvent to form a solid electrolyte interface (SEI) layer on the surface of a negative electrode before decomposition of the electrolyte, thereby suppressing or reducing a side reaction with the electrolyte and improving a swelling phenomenon.

If (e.g., when) the compound represented by Chemical Formula 1 and the positive electrode including lithium oxide are utilized in combination, transition metal elution may be effectively reduced under the condition of high voltage and high temperature, and thus structural collapse of the positive electrode may be suppressed or reduced to improve high-voltage and high-temperature characteristics of a battery.

In one or more embodiments, the compound represented by Chemical Formula 1 may be represented by Chemical Formula 1-1.

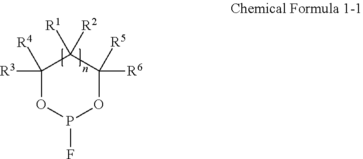

In Chemical Formula 1-1,
R¹ to R⁶ may each independently be hydrogen, a cyano group, an isocyanate group, an isothiocyanate group, a halogen-substituted sulfonate group, a sulfonate group substituted with a C1 to C10 alkyl group, a sulfonate group substituted by a C1 to C10 fluoroalkyl group, a substituted or unsubstituted C1 to C20 alkyl group, a substituted or unsubstituted C1 to C20 alkoxy group, a substituted or unsubstituted C2 to C20 alkenyl group, a substituted or unsubstituted C2 to C20 alkynyl group, a substituted or unsubstituted C3 to C20 cycloalkyl group, a substituted or unsubstituted C6 to C20 aryl group, or a substituted or unsubstituted C2 to C20 heteroaryl group.
n may be an integer of 0 or 1.

The compound represented by Chemical Formula 1-1 may have an electron-accepting fluorine substituent directly bonded to a central atom, phosphorus (P), thereby improving stability of the CEI layer present on the surface of the positive electrode and stability of the SEI layer present on the surface of the negative electrode.

In the electrolyte for a rechargeable lithium battery according to one or more embodiments, the compound represented by Chemical Formula 1 may be represented by Chemical Formula 1-1A or 1-1B.

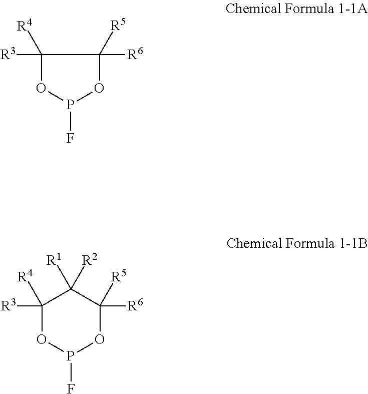

In Chemical Formula 1-1A and Chemical Formula 1-1B,
R¹ to R⁶ may each independently be hydrogen, a cyano group, an isocyanate group, an isothiocyanate group, a halogen-substituted sulfonate group, a sulfonate group substituted with a C1 to C5 alkyl group, a sulfonate group substituted with a C1 to C5 fluoroalkyl group, a substituted or unsubstituted C1 to C10 alkyl group, a substituted or unsubstituted C1 to C10 alkoxy group, a substituted or unsubstituted C2 to C10 alkenyl group, or a substituted or unsubstituted C2 to C10 alkynyl group.

According to one or more embodiments, R³ and R⁴ of Chemical Formula 1-1A may each be hydrogen.

R⁵ and R⁶ may each be hydrogen or any (e.g., at least) one selected from among R⁵ and R⁶ may each independently be selected from among a cyano group, an isocyanate group, an isothiocyanate group, a halogen-substituted sulfonate group, a sulfonate group substituted with a C1 to C5 alkyl group, a sulfonate group substituted with a C1 to C5 fluoroalkyl group, a substituted or unsubstituted C1 to C10 alkyl group, a substituted or unsubstituted C1 to C10 alkoxy group, a substituted or unsubstituted C2 to C10 alkenyl group, and/or a substituted or unsubstituted C2 to C10 alkynyl group.

According to one or more embodiments, the compound represented by Chemical Formula 1 may be selected from among compounds listed in Group 1. For example, the compound represented by Chemical Formula 1 may be any (e.g., at least) one selected from among 2-fluoro-1,3,2-dioxaphospholane and 2-fluoro-4-methyl-1,3,2-dioxaphospholane.

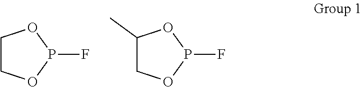

The compound represented by Chemical Formula 1 may be included in an amount of about 0.01 to 3 parts by weight, for example, about 0.1 to 2 parts by weight or about 0.1 to 1 parts by weight relative to 100 parts by weight of the electrolyte.

If (e.g., when) a usage amount of the compound represented by Chemical Formula 1 falls within the range described herein, a rechargeable lithium battery may improve in high-temperature storage characteristics and cycle-life properties.

According to one or more embodiments, the additive may include an aliphatic diisocyanate compound.

The compound represented by Chemical Formula 1 or some salt products formed from lithium salt may react with moisture to produce byproducts, and the byproducts may cause a swelling phenomenon or one or more undesired (e.g., side) reactions. The aliphatic diisocyanate compound may react with moisture to produce amine(s), and the amine(s) may react with residual aliphatic diisocyanate to produce polyurea, thereby effectively suppressing or reducing moisture in cells. Therefore, if (e.g., when) the aliphatic diisocyanate compound and the compound represented by Chemical Formula 1 are utilized in combination, there may be an improvement in cycle-life characteristics under the condition of high voltage and high temperature.

According to one or more embodiments, the aliphatic diisocyanate compound may include a C2 to C20 alicyclic diisocyanate compound.

The alicyclic diisocyanate compound may have a cyclic structure and excellent or suitable chemical resistance to stably form films on surfaces of positive and negative electrodes.

According to one or more embodiments, the aliphatic diisocyanate compound may include 1,6-hexamethylene diisocyanate (HDI), 4,4′-diisocyanate dicyclohexylmethane (H12MDI), 5-isocyanate-1-isocyanatomethyl-1,3,3-trimethylcyclohexane (isophorone diisocyanate, IPDI), and/or a (e.g. any suitable) combination thereof.

According to one or more embodiments, the aliphatic diisocyanate compound may be included in an amount of about 0.01 to 2 parts by weight, for example, about 0.1 to 1 parts by weight or about 0.25 to 0.5 parts by weight relative to 100 parts by weigh of the electrolyte. If (e.g., when) a usage amount of the aliphatic diisocyanate compound falls within the range described herein, a rechargeable lithium battery may improve in high-temperature storage characteristics and cycle-life properties.

According to one or more embodiments, the aliphatic diisocyanate compound and the compound represented by Chemical Formula 1 may be included in a weight ratio of about 2:1 to about 1:5, for example, about 1.5:1 to about 1:3 or about 1:1 to about 1:2. If (e.g., when) the aliphatic diisocyanate compound and the compound represented by Chemical Formula 1 are used in combination within the weight ratio range described herein, a rechargeable lithium battery may be achieved with an improvement in high-temperature storage characteristics and cycle-life properties.

At least one other additive may further be included in addition to the compound(s) mentioned herein.

The other additive may include at least one selected from among vinylene carbonate (VC), fluoroethylene carbonate (FEC), difluoroethylene carbonate, chloroethylene carbonate, dichloroethylene carbonate, bromoethylene carbonate, dibromoethylene carbonate, nitroethylene carbonate, cyanoethylene carbonate, vinylethylene carbonate (VEC), adiponitrile (AN), succinonitrile (SN), 1,3,6-hexane tricyanide (HTCN), propenesultone (PST), propanesultone (PS), lithium tetrafluoroborate (LiBF₄), lithium difluorophosphate (LiPO₂F₂), and 2-fluoro biphenyl (2-FBP).

The additional inclusion of the aforementioned other additive may further increase the cycle-life or effectively control or reduce gas generation from the positive and negative electrodes during high-temperature storage.

The additive may be included in an amount of about 0.02 to 10 parts by weight, for example, about 0.2 to 10 parts by weight or about 0.2 to 5 parts by weight relative to the total 100 parts by weight of the electrolyte for a rechargeable lithium battery.

If (e.g., when) an amount of the other additive is as herein described, an increase in film resistance may be minimized or reduced to contribute to an improvement in battery performance.

The following will describe an electrolyte for a rechargeable lithium battery according to one or more embodiments. As the same components thereof have substantially identical or similar functions and/or effects, a repetitive description thereof will not be provided hereinafter.

The electrolyte for a rechargeable lithium battery according to one or more embodiments may include a non-aqueous organic solvent, a lithium salt, and an additive. The additive may include an aliphatic diisocyanate compound and a compound represented by Chemical Formula 2.

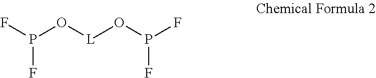

In Chemical Formula 2,
L may include a substituted or unsubstituted C1 to C10 alkylene group or a substituted or unsubstituted C2 to C10 ether group.

The compound represented by Chemical Formula 2 may stabilize a LiPF₆ salt in the electrolyte, thereby preventing or reducing hydrolysis (e.g., of the compounds and/or other components of the electrolyte).

The compound represented by Chemical Formula 2 may be oxidized on the surface of a positive electrode to form a phosphate functional group, and the functional group may serve as an anion receptor to stably form PF₆⁻ and to increase an ion pair separation of Li⁺ and PF₆⁻, with the result that solubility of LiF in the electrolyte may be improved to reduce interfacial resistance.

In some embodiments, the compound represented by Chemical Formula 2 may be oxidized and decomposed on the surface of the positive electrode to form a cathode electrolyte interface (CEI) layer with high heat resistance on the surface of the positive electrode, thereby suppressing or reducing decomposition of the electrolyte even at high-temperature storage.

For example, the compound represented by Chemical Formula 2 may have an oxidation potential less than that of a solvent to form a solid electrolyte interface (SEI) layer on the surface of a negative electrode before decomposition of the electrolyte, thereby suppressing or reducing a side reaction with the electrolyte and improving a swelling phenomenon.

If (e.g., when) the compound represented by Chemical Formula 2 and the positive electrode including lithium oxide are utilized in combination, transition metal elution may be effectively reduced under the condition of high voltage and high temperature, and thus structural collapse of the positive electrode may be suppressed or reduced to improve high-voltage and high-temperature characteristics of a battery.

In the electrolyte for a rechargeable lithium battery according to one or more embodiments, the compound represented by Chemical Formula 2 may be represented by Chemical Formula 2-1.

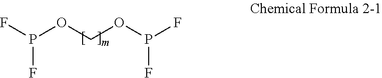

In Chemical Formula 2-1,
m may be one of integers of 1 to 5.

In the electrolyte for a rechargeable lithium battery according to one or more embodiments, the compound represented by Chemical Formula 2 may be represented by Chemical Formula 2-1A.

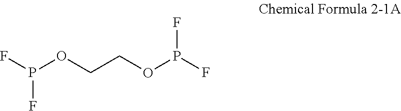

The compound represented by Chemical Formula 2 may be included in an amount of about 0.01 to 3 parts by weight, for example, about 0.1 to 2 parts by weight or about 0.1 to 1 parts by weight relative to 100 parts by weight of the electrolyte.

If (e.g., when) a usage amount of the compound represented by Chemical Formula 2 falls within the range described herein, a rechargeable lithium battery may be produced or achieved with an improvement in high-temperature storage characteristics and cycle-life properties.

The previously mentioned descriptions may be applied to a detailed description of the aliphatic diisocyanate compound, and thus a repetitive explanation thereof will not be provided hereinafter.

The aliphatic diisocyanate compound and the compound represented by Chemical Formula 2 may be included in a weight ratio of about 2:1 to about 1:5, for example, about 1.5:1 to about 1:3 or about 1:1 to about 1:2. If (e.g., when) the aliphatic diisocyanate compound and the compound represented by Chemical Formula 2 are used in combination within the weight ratio range described herein, a rechargeable lithium battery may be produced or achieved with an improvement in high-temperature storage characteristics and cycle-life properties.

The following will describe a rechargeable lithium battery according to one or more embodiments. As the same components have substantially identical or similar functions or effects, a repetitive description thereof will not be provided hereinafter.

A rechargeable lithium battery may include a positive electrode including a positive electrode active material, a negative electrode including a negative electrode active material, and the aforementioned electrolyte for the rechargeable lithium battery.

The compound represented by Chemical Formula 1 or 2 included in the electrolyte for a rechargeable lithium battery may have an oxidation potential less than that of a solvent to form a solid electrolyte interface (SEI) layer on the surface of a negative electrode before decomposition of the electrolyte. For example, the surface of the negative electrode may further include the solid electrolyte interface (SEI) layer.

In some embodiments, the compound represented by Chemical Formula 1 or 2 included in the electrolyte for a rechargeable lithium battery may be oxidized and decomposed on the surface of the positive electrode to form a cathode electrolyte interface (CEI) layer with high heat resistance on the surface of the positive electrode, thereby suppressing or reducing decomposition of the electrolyte even at high-temperature storage. For example, the surface of the positive electrode may further include the cathode electrolyte interface (CEI) layer.

The aliphatic diisocyanate compound included in the electrolyte for a rechargeable lithium battery may react with moisture to produced amine, and the amine may react with residual aliphatic diisocyanate to produce polyurea. The polyurea may be filed on the surfaces of the positive and negative electrodes to minimize or reduce an influence of moisture and to suppress or reduce a side reaction possibly occurring on the surfaces of the positive and negative electrodes. For example, the SEI layer may include polyurea. Moreover, the CEI layer may also include polyurea.

### Rechargeable Lithium Battery

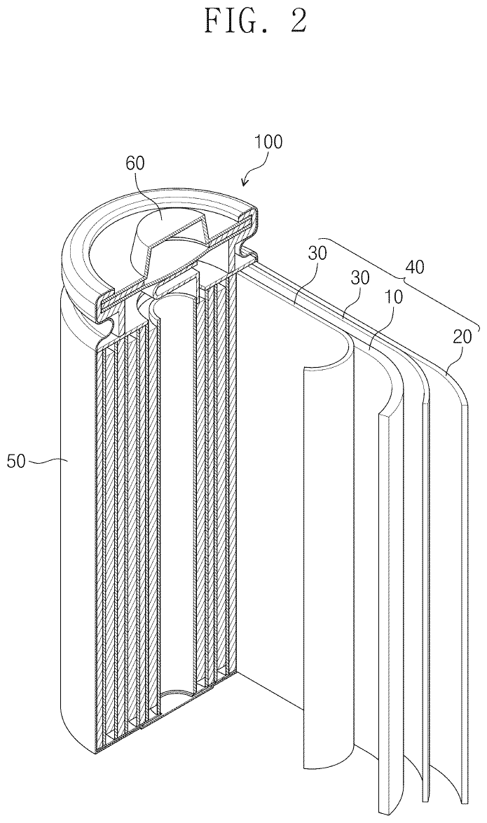

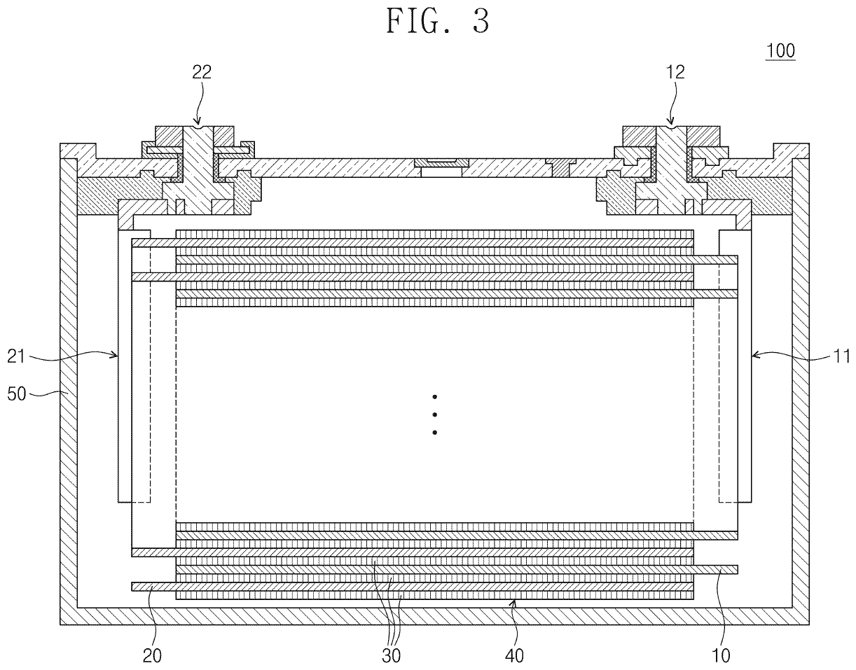

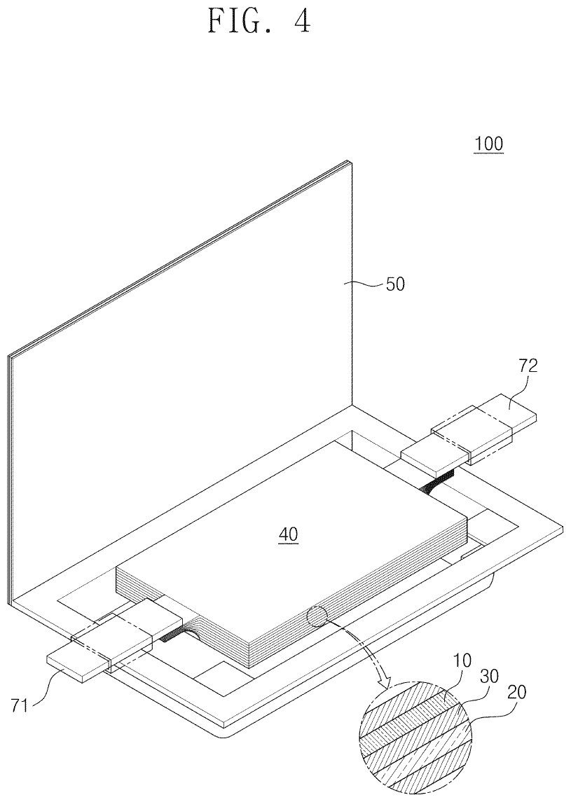

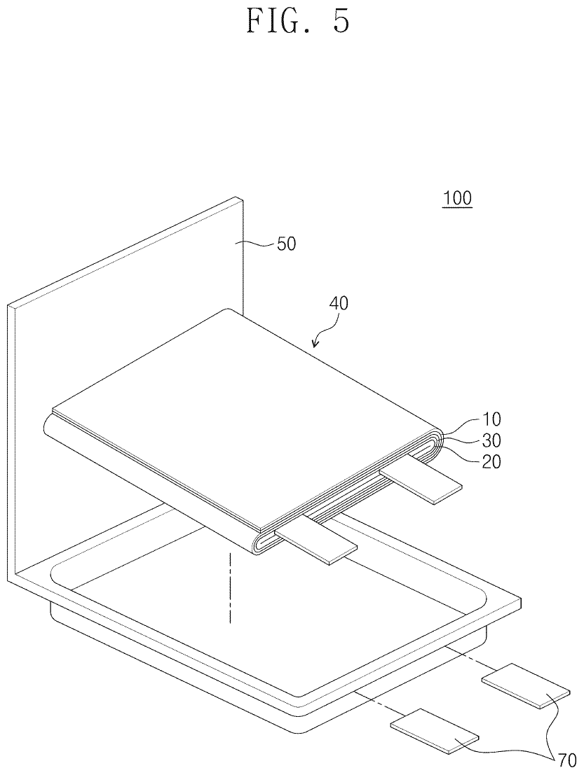

Based on shape of a rechargeable lithium battery, the rechargeable lithium battery may be classified into cylindrical, prismatic, pouch, and coin types (kinds). FIGS. 2 to 5 illustrate simplified diagrams each showing a rechargeable lithium battery according to one or more embodiments, with FIG. 2 showing a cylindrical battery, FIG. 3 showing a prismatic battery, and FIGS. 4 and 5 showing pouch-type (kind) batteries. Referring to FIGS. 2 to 4, a rechargeable lithium battery 100 may include an electrode assembly 40 in which a separator 30 is interposed between a positive electrode 10 and a negative electrode 20, and may also include a casing 50 in which the electrode assembly 40 is accommodated. The positive electrode 10, the negative electrode 20, and the separator 30 may be impregnated in an electrolyte (not shown). The rechargeable lithium battery 100 may include a sealing member 60 that seals the casing 50 as illustrated in FIG. 2. In some embodiments, as illustrated in FIG. 3, the rechargeable lithium battery 100 may include a positive electrode lead tab 11, a positive electrode terminal 12, a negative electrode lead tab 21, and a negative electrode terminal 22. As shown in FIGS. 4 and 5, the rechargeable lithium battery 100 may include electrode tabs 70, or a positive electrode tab 71 and a negative electrode tab 72, which electrode tabs 70, 71 and 72 serve as an electrical path for externally inducing a current generated in the electrode assembly 40.

The rechargeable lithium battery according to one or more embodiments of the present disclosure may be applied to automotive vehicles, mobile phones, and/or any other electrical devices, but the present disclosure is not limited thereto.

Terms such as “substantially,” “about,” and “approximately” are used as relative terms and not as terms of degree, and are intended to account for the inherent deviations in measured or calculated values that would be recognized by those of ordinary skill in the art. They may be inclusive of the stated value and an acceptable range of deviation as determined by one of ordinary skill in the art, considering the limitations and error associated with measurement of that quantity. For example, “about” may refer to one or more standard deviations, or +30%, 20%, 10%, 5% of the stated value.

Numerical ranges disclosed herein include and are intended to disclose all subsumed sub-ranges of the same numerical precision. For example, a range of “1.0 to 10.0” includes all subranges having a minimum value equal to or greater than 1.0 and a maximum value equal to or less than 10.0, such as, for example, 2.4 to 7.6. Applicant therefore reserves the right to amend this specification, including the claims, to expressly recite any sub-range subsumed within the ranges expressly recited herein.

The following will describe example embodiments and comparative examples of the present disclosure. The following example embodiments, however, are merely one or more possible examples, and the present disclosure is not limited to the one or more following example embodiments.

### EXAMPLE EMBODIMENTS AND COMPARATIVE EXAMPLES

An electrolyte and a rechargeable lithium battery were fabricated by the following methods.

### Example Embodiment 1

### (1) Preparation of Electrolyte

1.5M LiPF₆ was dissolved in a non-aqueous organic solvent including ethylene carbonate (EC), ethylmethyl carbonate (EMC), and dimethyl carbonate (DMC) mixed in a volume ratio of 20:40:40, and an additive was added to prepare an electrolyte.

The additive was prepared by mixing a compound represented by Chemical Formula A in an amount of 0.25 wt % relative to the total 100 wt % of the electrolyte and a compound represented by Chemical Formula B in an amount of 0.5 wt % relative to the total 100 wt % of the electrolyte.

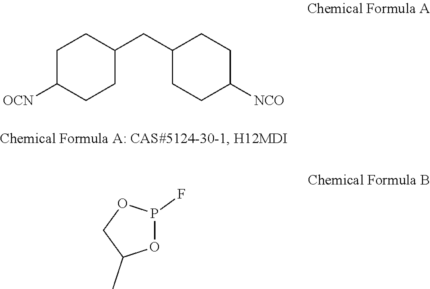

### (2) Fabrication of Rechargeable Lithium Battery

LiNi_{0.91}Co_{0.07}Al_{0.02}O₂ as a positive electrode active material, polyvinylidene fluoride as a binder, and Ketjen black as a conductive material were mixed in a weight ratio of 97:2:1, and the mixture was dispersed in N-methyl pyrrolidone to prepare a positive electrode active material slurry.

The positive electrode active material slurry was coated on an Al foil of 14 micrometer (μm) in thickness, dried at 110° C., and then pressed to manufacture a positive electrode.

Artificial graphite and a Si—C composite mixed in a weight ratio of 93:7 as a negative electrode active material, styrene butadiene rubber as a binder, and carboxymethyl cellulose as a thickener were mixed in a weight ratio of 97:1:2, and the mixture was dispersed in distilled water to prepare a negative electrode active material slurry.

The Si—C composite included a core including artificial graphite and silicon particles, and a coal-based pitch coated on a surface of the core.

The negative electrode active material slurry was coated on a Cu foil of 10 μm in thickness, dried at 100° C., and then pressed to manufacture a negative electrode.

The positive electrode, the negative electrode, and a polyethylene separator of 25 μm in thickness were assembled to manufacture an electrode assembly, and the electrolyte was introduced to fabricate a rechargeable lithium battery.

### Example Embodiment 2

A rechargeable lithium battery was fabricated in substantially the same method as in Example Embodiment 1, except that the additive was prepared by mixing a compound represented by Chemical Formula A (H12MDI) in an amount of 0.5 wt % relative to the total 100 wt % of the electrolyte.

### Example Embodiment 3

A rechargeable lithium battery was fabricated in substantially the same method as in Example Embodiment 1, except that the additive was prepared by mixing a compound represented by Chemical Formula C (e.g., IPDI), instead of Chemical Formula A, in an amount of 0.25 wt % relative to the total 100 wt % of the electrolyte and a compound represented by Chemical Formula B in an amount of 0.5 wt % relative to the total 100 wt % of the electrolyte.

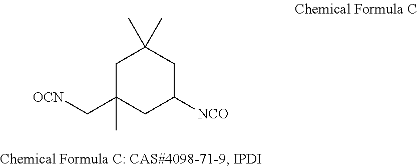

### Example Embodiment 4

A rechargeable lithium battery was fabricated in substantially the same method as in Example Embodiment 1, except that the additive was prepared by mixing a compound represented by Chemical Formula C, instead of Chemical Formula A, in an amount of 0.5 wt % relative to the total 100 wt % of the electrolyte and a compound represented by Chemical Formula B in an amount of 0.5 wt % relative to the total 100 wt % of the electrolyte.

### Example Embodiment 5

A rechargeable lithium battery was fabricated in substantially the same method as in Example Embodiment 1, except that the additive was prepared by mixing a compound represented by Chemical Formula A in an amount of 0.25 wt % relative to the total 100 wt % of the electrolyte and a compound represented by Chemical Formula 2-1A, instead of Chemical Formula B, in an amount of 0.5 wt % relative to the total 100 wt % of the electrolyte.

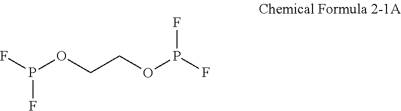

### Example Embodiment 6

A rechargeable lithium battery was fabricated in substantially the same method as in Example Embodiment 1, except that the additive was prepared by mixing a compound represented by Chemical Formula A in an amount of 0.5 wt % relative to the total 100 wt % of the electrolyte and a compound represented by Chemical Formula 2-1A, instead of Chemical Formula B, in an amount of 0.5 wt % relative to the total 100 wt % of the electrolyte.

### Example Embodiment 7

A rechargeable lithium battery was fabricated in substantially the same method as in Example Embodiment 1, except that the additive was prepared by mixing a compound represented by Chemical Formula C, instead of Chemical Formula A, in an amount of 0.25 wt % relative to the total 100 wt % of the electrolyte and a compound represented by Chemical Formula 2-1A, instead of Chemical Formula B, in an amount of 0.5 wt % relative to the total 100 wt % of the electrolyte.

### Example Embodiment 8

A rechargeable lithium battery was fabricated in substantially the same method as in Example Embodiment 1, except that the additive was prepared by mixing a compound represented by Chemical Formula C in an amount of 0.5 wt % relative to the total 100 wt % of the electrolyte and a compound represented by Chemical Formula 2-1A, instead of Chemical Formula B, in an amount of 0.5 wt % relative to the total 100 wt % of the electrolyte.

### Comparative Example 1

A rechargeable lithium battery was fabricated in substantially the same method as in Example Embodiment 1, except that no additive was added.

### Comparative Example 2

A rechargeable lithium battery was fabricated in substantially the same method as in Example Embodiment 1, except that the additive was prepared by adding a compound represented by Chemical Formula B in an amount of 0.5 wt % relative to the total 100 wt % of the electrolyte and not adding a compound represented by Chemical Formula A.

### Comparative Example 3

A rechargeable lithium battery was fabricated in substantially the same method as in Example Embodiment 1, except that the additive was prepared by adding a compound represented by Chemical Formula 2-1A, instead of Chemical Formula B, in an amount of 0.5 wt % relative to the total 100 wt % of the electrolyte and not adding a compound represented by Chemical Formula A.

Table 1 shows additive compositions of electrolytes for rechargeable lithium batteries according to Example Embodiments 1 to 8 and Comparative Examples 1 to 3.

TABLE 1

| | | | Fluorophosphate | |
|---|---|---|---|---|
| | | | Chemical | Chemical |
| | Diisocyanate | | Formula | Formula |
| | H12MDI | IPDI | B | 2-1A |
| Example ID | (wt %*) | (wt %) | (wt %) | (wt %) |
| Embodiment 1 | 0.25 | —** | 0.5 | — |
| Embodiment 2 | 0.5 | — | 0.5 | — |
| Embodiment 3 | — | 0.25 | 0.5 | — |
| Embodiment 4 | — | 0.5 | 0.5 | — |
| Embodiment 5 | 0.25 | — | — | 0.5 |
| Embodiment 6 | 0.5 | — | — | 0.5 |
| Embodiment 7 | — | 0.25 | — | 0.5 |
| Embodiment 8 | — | 0.5 | — | 0.5 |
| Comparative 1 | — | — | — | — |
| Comparative 2 | — | — | 0.5 | — |
| Comparative 3 | — | — | — | 0.5 |

*The value of wt % is based on the total 100 wt % of the electrolyte.
**The mark “—” indicates no addition during the preparation of the electrolyte.

### Evaluation Example

### Evaluation 1: Cycle Characteristics at Room Temperature (Capacity Retention Rate and DCIR Increase Rate)

The rechargeable lithium batteries fabricated according to Example Embodiments 1 to 8 and Comparative Examples 1 to 3 were charged and discharged once at 0.2 C to thereby measure charge and discharge capacities (initial capacity). The rechargeable lithium batteries fabricated according to Embodiments 1 to 8 and Comparatives 1 to 3 were charged and discharged at room temperature (25° C.) with a voltage range of 2.75 V to 4.25 V at a 0.5 C-rate for 1000 cycles, and a discharge capacity at 1000 cycles was measured. An initial capacity and a discharge capacity at 1000 cycles (1000 cycles discharge capacity) were substituted into Equation 1 to calculate a capacity retention rate (at 1000 cycles, %), and the calculated value is shown in Table 2.

$$Capacity retention rate ( \% ) = \{ 1000 cycles discharge capacity / initial capacity \} \times 100 \qquad [ Equation 1 ]$$

The rechargeable lithium batteries fabricated according to Embodiments 1 to 8 and Comparatives 1 to 3 were allowed to measure their initial direct-current internal resistance (initial DCIR) as AV/AI (voltage change/current change). The rechargeable lithium batteries fabricated according to Embodiments 1 to 8 and Comparatives 1 to 3 were charged and discharged at room temperature (25° C.) with a voltage range of 2.75 V to 4.25 V at a 0.5 C-rate for 1000 cycles, and a direct-current internal resistance at 1,000 cycles (1000 cycles DCIR) was measured. A DCIR increase rate (%) was calculated according to Equation 2, and the result is listed in Table 2.

$$DCIR increase rate ( \% ) = ( 1000 cycles DCIR / initial DCIR ) \times 100 \qquad [ Equation 2 ]$$

TABLE 2

| | Capacity retention | DCIR increase |
|---|---|---|
| | rate | rate |
| Example ID | (@1000 cycles, %) | (@1000 cycles, %) |
| Embodiment 1 | 93.2 | 101.1 |
| Embodiment 2 | 93.0 | 101.2 |
| Embodiment 3 | 87.5 | 102.7 |
| Embodiment 4 | 86.4 | 105.1 |
| Embodiment 5 | 85.5 | 104.7 |
| Embodiment 6 | 86.0 | 104.9 |
| Embodiment 7 | 87.0 | 103.5 |
| Embodiment 8 | 86.6 | 102.3 |
| Comparative 1 | 82.1 | 113.2 |
| Comparative 2 | 83.5 | 110.5 |
| Comparative 3 | 83.3 | 111.1 |

Referring to Table 2, it may be observed that, compared to the rechargeable lithium batteries of Comparatives 1 to 3, the rechargeable lithium batteries of Embodiments 1 to 8 have an increased capacity retention rate and a reduced DCIR increase rate. For these reasons, it may be ascertained that, compared to the rechargeable lithium batteries of Comparatives 1 to 3, the rechargeable lithium batteries of Embodiments 1 to 8 have improved cycle characteristics. Evaluation 2: Storage Characteristics at High Temperature (60° C.) (Capacity Retention Rate and DCIR Increase Rate)

The rechargeable lithium batteries fabricated according to Embodiments 1 to 8 and Comparatives 1 to 3 were charged and discharged once at 0.2 C to thereby measure charge and discharge capacities (initial capacity). The rechargeable lithium batteries fabricated according to Embodiments 1 to 8 and Comparatives 1 to 3 were charged at a 0.2 C-rate to reach 4.25 V, and then rested at 60° C. for 60 days. The rechargeable lithium batteries were discharged at a 0.5 C-rate to reach 2.75 V, and then a discharge capacity (60 days discharge capacity) was measured after being rested at high temperatures The measured initial capacity and discharge capacity were substituted into Equation 3 to calculate a high-temperature storage capacity retention rate. The result is listed in Table 3.

$$High - temperature storage capacity retention rate ( \% ) = \{ 60 days discharge capacity / initial capacity \} \times 100 \qquad [ Equation 3 ]$$

The rechargeable lithium batteries fabricated according to Embodiments 1 to 8 and Comparatives 1 to 3 were allowed to measure their initial direct-current internal resistance (initial DCIR) as AV/AI (voltage change/current change). The rechargeable lithium batteries fabricated according to Embodiments 1 to 8 and Comparatives 1 to 3 were allowed to measure their initial direct-current internal resistance (post-high-temperature-storage DCIR) as AV/AI (voltage change/current change) after being rested at a high temperature (60° C.) for 60 days. A post-high-temperature-storage DCIR increase rate (%) was calculated according to Equation 4, and the result is listed in Table 3.

$$Post - high - temperature - storage DCIR increase rate ( \% ) = ( DCIR after high - temperature storage / initial DCIR ) \times 100 \qquad [ Equation 4 ]$$

TABLE 3

| | High-temperature storage | Post-high-temperature- |
|---|---|---|
| | capacity retention rate | storage DCIR increase rate |
| Example ID | (@60° C., @60 Days, %) | (@60° C., @60 Days, %) |
| Embodiment 1 | 97.2 | 104.5 |
| Embodiment 2 | 96.4 | 106.1 |
| Embodiment 3 | 94.6 | 105.7 |
| Embodiment 4 | 94.5 | 110.0 |
| Embodiment 5 | 94.2 | 107.8 |
| Embodiment 6 | 94.9 | 112.3 |
| Embodiment 7 | 95.5 | 106.7 |
| Embodiment 8 | 95.3 | 105.2 |
| Comparative 1 | 92.7 | 118.8 |
| Comparative 2 | 93.2 | 115.4 |
| Comparative 3 | 93.5 | 114.7 |

Referring to Table 3, it may be observed that, compared to the rechargeable lithium batteries of Comparatives 1 to 3, the rechargeable lithium batteries of Embodiments 1 to 8 have their increased capacity retention rate after high-temperature storage and reduced DCIR increase rate after high-temperature storage. For these reasons, it may be ascertained that, compared to the rechargeable lithium batteries of Comparatives 1 to 3, the rechargeable lithium batteries of Embodiments 1 to 8 have improved cycle characteristics.

The electrolyte for a rechargeable lithium battery according to one or more embodiments may be applied to achieve the rechargeable lithium battery whose resistance increase is suppressed or reduced at high-temperature storage and whose stability and cycle-life characteristics are excellent or suitable.

A battery manufacturing device, a battery management system (BMS) device, and/or any other relevant devices or components according to embodiments of the present disclosure described herein may be implemented utilizing any suitable hardware, firmware (e.g., an application-specific integrated circuit), software, or a combination of software, firmware, and hardware. For example, the components of the device may be formed on one integrated circuit (IC) chip or on separate IC chips. Further, the components of the device may be implemented on a flexible printed circuit film, a tape carrier package (TCP), a printed circuit board (PCB), or formed on one substrate. Further, the components of the device may be a process or thread, running on one or more processors, in one or more computing devices, executing computer program instructions and interacting with other system components for performing the functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, and/or the like. Also, a person of skill in the art should recognize that the functionality of computing devices may be combined or integrated into a single computing device, or the functionality of a particular computing device may be distributed across one or more other computing devices without departing from the scope of the present disclosure.

Descriptions of features or aspects within each embodiment should typically be considered as available for other similar features or aspects in other embodiments.

While this disclosure has been described in connection with what is presently considered to be example embodiments, it is to be understood that the present disclosure is not limited to the disclosed embodiments. Instead, it is intended to cover one or more suitable modifications and equivalent arrangements included within the spirit and scope of the appended claims, and equivalents thereof. Therefore the aforementioned embodiments should be understood to be merely examples but not limiting this disclosure in any way.

What is claimed is:

1. An electrolyte comprising:
a non-aqueous organic solvent;
a lithium salt; and
an additive,
wherein the additive comprises:
an aliphatic diisocyanate compound; and
a compound represented by Chemical Formula 1, 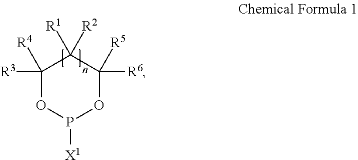
and
wherein, in Chemical Formula 1,
X¹ is a fluoro group, a chloro group, a bromo group, or an iodo group,
R¹ to R⁶ are each independently hydrogen, a cyano group, an isocyanate group, an isothiocyanate group, a halogen-substituted sulfonate group, a sulfonate group substituted with a C1 to C10 alkyl group, a sulfonate group substituted by a C1 to C10 fluoroalkyl group, a substituted or unsubstituted C1 to C20 alkyl group, a substituted or unsubstituted C1 to C20 alkoxy group, a substituted or unsubstituted C2 to C20 alkenyl group, a substituted or unsubstituted C2 to C20 alkynyl group, a substituted or unsubstituted C3 to C20 cycloalkyl group, a substituted or unsubstituted C6 to C20 aryl group, or a substituted or unsubstituted C2 to C20 heteroaryl group, and
n is an integer of 0 or 1,
the electrolyte being for a rechargeable lithium battery.

2. The electrolyte of claim 1, wherein the compound is represented by Chemical Formula 1-1, 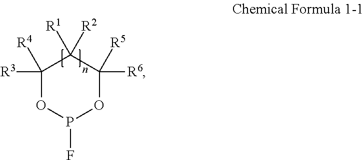
and
wherein, in Chemical Formula 1-1,
R¹ to R⁶ are each independently hydrogen, a cyano group, an isocyanate group, an isothiocyanate group, a halogen-substituted sulfonate group, a sulfonate group substituted with a C1 to C10 alkyl group, a sulfonate group substituted by a C1 to C10 fluoroalkyl group, a substituted or unsubstituted C1 to C20 alkyl group, a substituted or unsubstituted C1 to C20 alkoxy group, a substituted or unsubstituted C2 to C20 alkenyl group, a substituted or unsubstituted C2 to C20 alkynyl group, a substituted or unsubstituted C3 to C20 cycloalkyl group, a substituted or unsubstituted C6 to C20 aryl group, or a substituted or unsubstituted C2 to C20 heteroaryl group, and
n is an integer of 0 or 1.

3. The electrolyte of claim 2, wherein the compound is represented by Chemical Formula 1-1A or Chemical Formula 1-1B, 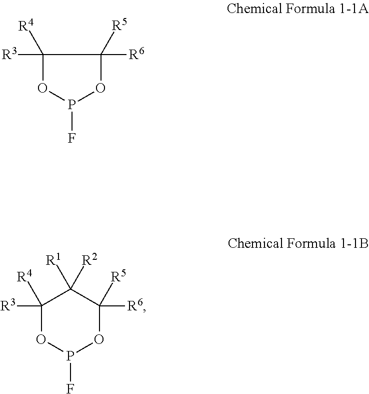
and
wherein, in Chemical Formula 1-1A and Chemical Formula 1-1B,
R¹ to R⁶ are each independently hydrogen, a cyano group, an isocyanate group, an isothiocyanate group, a halogen-substituted sulfonate group, a sulfonate group substituted with a C1 to C5 alkyl group, a sulfonate group substituted with a C1 to C5 fluoroalkyl group, a substituted or unsubstituted C1 to C10 alkyl group, a substituted or unsubstituted C1 to C10 alkoxy group, a substituted or unsubstituted C2 to C10 alkenyl group, or a substituted or unsubstituted C2 to C10 alkynyl group.

4. The electrolyte of claim 3, wherein,
in Chemical Formula 1-1A,
R³ and R⁴ are each hydrogen, and
R⁵ and R⁶ are each independently hydrogen or any one selected from among R⁵ and R⁶ is a cyano group, an isocyanate group, an isothiocyanate group, a halogen-substituted sulfonate group, a sulfonate group substituted with a C1 to C5 alkyl group, a sulfonate group substituted with a C1 to C5 fluoroalkyl group, a substituted or unsubstituted C1 to C10 alkyl group, a substituted or unsubstituted C1 to C10 alkoxy group, a substituted or unsubstituted C2 to C10 alkenyl group, or a substituted or unsubstituted C2 to C10 alkynyl group.

5. The electrolyte of claim 1, wherein the compound is any one selected from among compounds listed in Group 1,

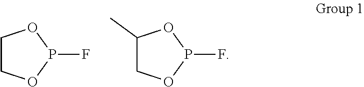

6. The electrolyte of claim 1, wherein the aliphatic diisocyanate compound comprises a C2 to C20 alicyclic diisocyanate compound.

7. The electrolyte of claim 1, wherein the aliphatic diisocyanate compound comprises 1,6-hexamethylene diisocyanate (HDI), 4,4′-diisocyanate dicyclohexylmethane (H12MDI), 5-isocyanate-1-isocyanatomethyl-1,3,3-trimethylcyclohexane (isophorone diisocyanate, IPDI), or a combination thereof.

8. The electrolyte of claim 1, wherein the additive is comprised in an amount of about 0.02 to 10 parts by weight relative to 100 parts by weight of the electrolyte.

9. The electrolyte of claim 1, wherein,
the aliphatic diisocyanate compound is comprised in an amount of about 0.01 to 2 parts by weight relative to 100 parts by weight of the electrolyte, and
the compound represented by Chemical Formula 1 is comprised in an amount of about 0.01 to 3 parts by weight relative to 100 parts by weight of the electrolyte.

10. The electrolyte of claim 1, wherein the aliphatic diisocyanate compound and the compound represented by Chemical Formula 1 are comprised in a weight ratio of about 2:1 to about 1:5.

11. An electrolyte comprising:
a non-aqueous organic solvent;
a lithium salt; and
an additive,
wherein the additive comprises:
an aliphatic diisocyanate compound; and
a compound represented by Chemical Formula 2, 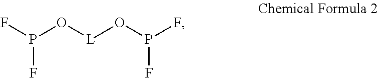
and
wherein, in Chemical Formula 2, L comprises a substituted or unsubstituted C1 to C10 alkylene group or a substituted or unsubstituted C2 to C10 ether group,
the electrolyte being for a rechargeable lithium battery.

12. The electrolyte of claim 11, wherein the compound is represented by Chemical Formula 2-1, 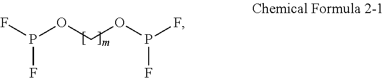
and
wherein, in Chemical Formula 2-1, m is an integer of 1 to 5.

13. The electrolyte of claim 11, wherein the compound is represented by Chemical Formula 2-1A,

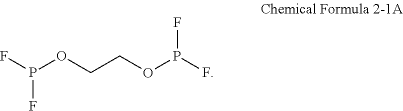

14. The electrolyte of claim 11, wherein the aliphatic diisocyanate compound comprises a C2 to C20 alicyclic diisocyanate compound.

15. The electrolyte of claim 11, wherein the aliphatic diisocyanate compound comprises 1,6-hexamethylene diisocyanate (HDI), 4,4′-diisocyanate dicyclohexylmethane (H12MDI), 5-isocyanate-1-isocyanatomethyl-1,3,3-trimethylcyclohexane (isophorone diisocyanate, IPDI), or a combination thereof.

16. The electrolyte of claim 11, wherein the aliphatic diisocyanate compound and the compound represented by Chemical Formula 2 are comprised in a weight ratio of about 2:1 to about 1:5.

17. The electrolyte of claim 11, wherein,
the aliphatic diisocyanate compound is comprised in an amount of about 0.01 to 2 parts by weight relative to 100 parts by weight of the electrolyte, and
the compound represented by Chemical Formula 2 is comprised in an amount of about 0.01 to 3 parts by weight relative to 100 parts by weight of the electrolyte.

18. A rechargeable lithium battery, comprising:
a positive electrode that comprises a positive electrode active material;
a negative electrode that comprises a negative electrode active material; and
the electrolyte as set forth in claim 1.

19. The rechargeable lithium battery of claim 18, wherein,
a surface of the negative electrode comprises a solid electrolyte interface (SEI) layer, and
the SEI layer comprises a polyurea.

20. The rechargeable lithium battery of claim 18, wherein,
a surface of the positive electrode comprises a cathode electrolyte interface (CEI) layer, and
the CEI layer comprises a polyurea.
